(19) United States
(12) Patent Application Publication
(10) Pub. No.: US 2017/0193604 A1
(43) Pub. Date: Jul. 6, 2017

(54) INTELLIGENCE ASSESSMENT AND ACTION TRIGGERING AND ALERTING SYSTEM

(71) Applicant: Bank of America Corporation, Charlotte, NC (US)

(72) Inventors: Joseph Neil Johansen, Rock Hill, SC (US); Christopher Shawn Vale, Topsfield, MA (US); Alexander C. Wittkowski, Charlotte, NC (US); Anthony David Guido, Corona, CA (US); Robert Scott Seidman, Matthews, NC (US); Michael Ma, Tappan, NY (US)

(21) Appl. No.: 14/987,145

(22) Filed: Jan. 4, 2016

(51) Int. Cl. G06Q 40/06; G06F 17/30

(52) U.S. Cl. CPC G06Q 40/06; G06F 17/3053

(57) ABSTRACT

Embodiments of the invention provide for systems, computer program products, and methods for a financial wellness application that provides an overview of the financial well-being of users. The financial wellness of the users may be determined by identifying personal characteristics of the users regarding background information about the users and the users' households. Based on a user's personal characteristics, financial wellness questions are determined from a plurality of financial wellness questions to present to the user for which the user provides financial wellness input. The financial wellness input is transformed into a financial situation assessment, day-to-day management assessment, and preparation for the future assessment, which are transformed into an overall wellness score. Moreover, the financial wellness input may also be compared against financial wellness thresholds. As such, when the user's financial wellness input fails to meet the threshold values it may trigger the display of actionable advice for the user.

### FIELD

The present invention relates to systems for transforming user information into an assessment of the user's financial wellness and for providing advice and products to improve the user's financial wellness.

### BACKGROUND

Managing expenses and planning for retirement are actions that are becoming more important to people. The more tools a person or company has, and/or the better the tools are for predicting a person's ability to manage finances and plan for retirement, the better a person will be able to manage expenses and plan for retirement and the better a company will be at providing products that accomplish these goals for the person.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for a financial wellness application that provides an overview of the financial well-being of users (e.g., customers of a financial institution, or the like). The financial wellness of the users may be determined by identifying personal characteristics of the users regarding background information about the users and the users' households. The personal characteristics may be determined by the users answering personal characteristic questions or by the finial institution automatically accessing user profile information or user account information to identify the personal characteristics. Based on a user's personal characteristics, financial wellness questions are determined from a plurality of financial wellness questions to present to the user. The user provides financial wellness input regarding the financial wellness questions. The financial wellness input is transformed into a financial situation assessment, day-to-day management assessment, and preparation for the future assessment, which are transformed into an overall wellness score. Moreover, the financial wellness input for the one or more financial wellness questions may also be compared against financial wellness thresholds. As such, when the user's financial wellness input fails to meet the threshold values it may trigger the display of actionable advice for the user. The actionable advice may include suggestions for the user to improve the user's financial wellness, articles related to tips for managing expenses, savings, and investments, and proposed product (e.g., financial services, or the like) offers that may help improve the user's wellness score and the user's management of the user's finances.

When the user has taken one or more actions corresponding to the actionable advice and has improved the overall wellness and/or intelligence score, a recommended product offer may be presented to the user. In some cases, one or more problems associated with the user are predicted and a stress test is performed. The stress test is configured to test the user's ability to handle the predicted one or more problems and results in a stress score. In response to the stress score moving past a threshold, second actionable advice may be presented to the user. The second actionable advice is configured to improve the user's ability to handle the predicted one or more problems.

Embodiments of the invention comprise systems, computer program products, and methods for transforming user information into a determination of the financial wellness of a user. The invention comprises presenting personal characteristic questions to the user, wherein the personal characteristic questions comprise financial history information about the user and the user's household, and wherein the personal characteristic questions are presented to the user through a user interface on a user device. The invention further comprises receiving personal characteristic inputs in response to the personal characteristic questions. The invention also comprises determining financial wellness assessment questions to present to the user from a plurality of financial wellness assessment questions, wherein the financial wellness assessment questions are determined based on the personal characteristic inputs received for the personal characteristics questions, wherein the financial wellness assessment questions relate to the user's financial situation, the user's day-to-day financial management, and the user's preparation for the future, and wherein the plurality of financial wellness assessments questions are stored on one or more servers. The invention also comprises presenting the financial wellness assessment questions to the user, wherein the financial wellness assessment questions are presented to the user on the user interface of the user device. Thereafter, the invention comprises receiving financial wellness assessment inputs from the user in response to the financial wellness assessment questions, wherein the financial wellness assessment inputs are received from the user through the user interface on the user device. The invention also comprises transforming the financial wellness assessments inputs from the user into a financial situation score that measures a value of the user's net worth, a day-to-day financial management score that measures how the user handles current finances, and a preparing for the future score that measures how the user plans for long-term financial needs. The invention further comprises transforming the financial situation score, the day-to-day financial management score, and the preparing for the future score into an overall financial wellness score. The invention further identifies one or more rules from a plurality of rules for one or more of the financial wellness questions or the personal characteristic questions, wherein the one or more rules are used to determine actionable advice for the user, wherein the actionable advice is determined when a threshold response for the one or more rules is violated by the financial wellness assessment inputs or the personal characteristic inputs, and wherein the plurality of rules are stored on one or more servers. The invention also comprises presenting the actionable advice to the user on the user interface of the user device, wherein the actionable advice comprises tips, articles, or recommended product offers associated with the one or more rules that were violated by the financial wellness assessment inputs or the personal characteristic inputs, wherein the actionable advice is related to improving the overall wellness score of the user, wherein the actionable advice is stored on one or more servers, and wherein the actionable advice comprises tips, articles, or recommended product offers that are identified from third-party systems or one or more financial institution systems.

In further accord with an embodiment of the invention, the personal characteristic inputs are received automatically through accessing user profile information or user account information stored on the one or more financial institution systems.

In another embodiment of the invention, the personal characteristic inputs are received from the user through the user interface on the user device.

In still another embodiment of the invention, at least one of the financial wellness assessment inputs are received automatically through accessing user profile information or user account information stored on the one or more financial institution systems.

In yet another embodiment of the invention, the financial situation score is based on financial wellness assessment questions related to the user's assets and the user's liabilities.

In further accord with an embodiment of the invention, the day-to-day financial management score is based on financial wellness assessment questions related to the user's liquidity management, budgeting, debt management, and financial planning.

In another embodiment of the invention, the preparing for the future score is based on financial wellness assessment questions related to the user's education management, personal development, investing management, retirement planning, insurance management, and estate planning.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of a financial wellness system environment, in accordance with an embodiment of the invention.

FIG. 2 illustrates a high level process flow of a financial wellness determination method, in accordance with one embodiment of the invention.

FIG. 3 illustrates a detailed process flow of a financial wellness determination method, in accordance with one embodiment of the invention.

FIG. 4 illustrates a personal characteristic question interface, in accordance with one embodiment of the invention.

FIG. 5A illustrates a financial wellness assessment question interface, in accordance with an embodiment of the invention.

FIG. 5B illustrates a continuation of the financial wellness assessment question interface from FIG. 5A, in accordance with an embodiment of the invention.

FIG. 6 illustrates a financial wellness assessment scoring block diagram, in accordance with an embodiment of the invention.

FIG. 7 illustrates an actionable advice rules diagram, in accordance with an embodiment of the invention.

FIG. 8 illustrates an actionable advice rules diagram, in accordance with an embodiment of the invention.

FIG. 9 illustrates an actionable advice rules diagram, in accordance with an embodiment of the invention.

FIG. 10 illustrates a method for intelligence assessment and action triggering in accordance with embodiments of the invention.

FIG. 11 illustrates another method for intelligence assessment and action triggering in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout. As such, methods, systems, computer programs, and the like, are herein disclosed that provide for a financial wellness application for transforming customer information into useable information for determining the financial wellness of the customer and actionable items for improving the financial wellness.

Generally, systems, computer program products, and methods are described herein for a financial wellness application that provides an overview of the financial well-being of users (e.g., customers of a financial institution, or the like). The financial wellness of the users may be determined by identifying personal characteristics of the users regarding background information about the users and the users' households. The personal characteristics may be determined by the users answering personal characteristic questions or by the finial institution automatically accessing user profile information or user account information to identify the personal characteristics. Based on a user's personal characteristics, financial wellness questions are determined from a plurality of financial wellness questions to present to the user. The user provides financial wellness input regarding the financial wellness questions. The financial wellness input is transformed into a financial situation assessment, day-to-day management assessment, and preparation for the future assessment, which are transformed into an overall wellness score. Moreover, the financial wellness input for the one or more financial wellness questions may also be compared against financial wellness thresholds. As such, when the user's financial wellness input fails to meet the threshold values it may trigger the display of actionable advice for the user. The actionable advice may include suggestions for the user to improve the user's financial wellness, articles related to tips for managing expenses, savings, and investments, and proposed product (e.g., financial services, or the like) offers that may help improve the user's wellness score and the user's management of the user's finances.

When the user has taken one or more actions corresponding to the actionable advice and has improved the overall wellness and/or intelligence score, a recommended product offer may be presented to the user. In some cases, one or more problems associated with the user are predicted and a stress test is performed. The stress test is configured to test the user's ability to handle the predicted one or more problems and results in a stress score. In response to the stress score moving past a threshold, second actionable advice may be presented to the user. The second actionable advice is configured to improve the user's ability to handle the predicted one or more problems.

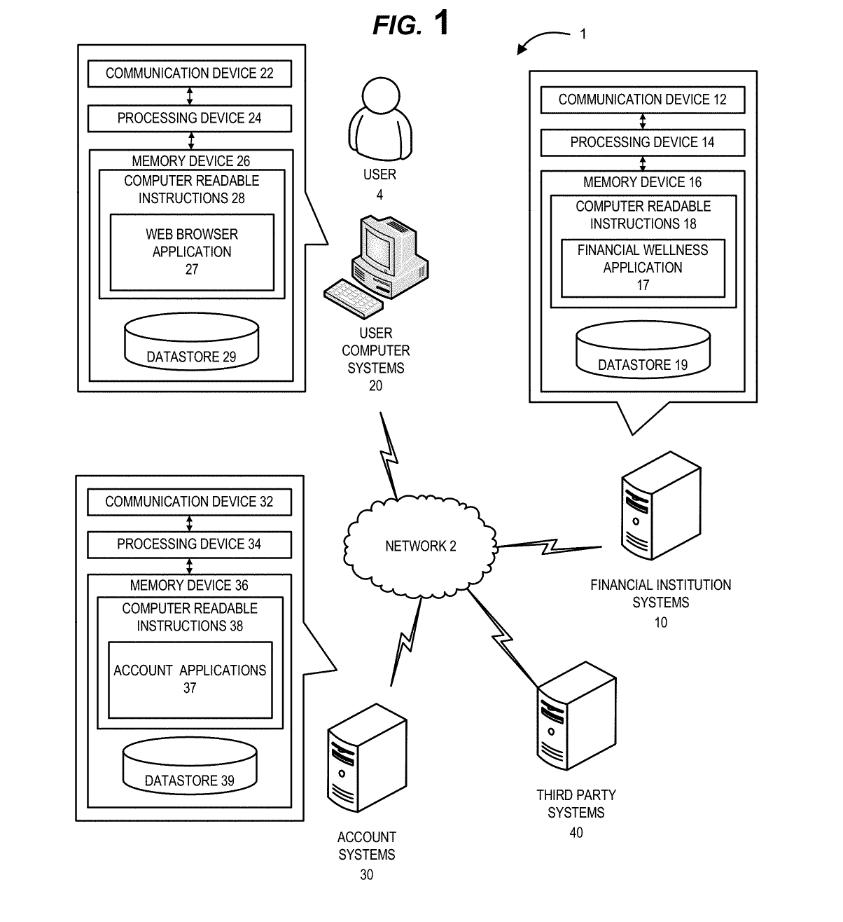

FIG. 1 illustrates a financial wellness system environment 1, in accordance with an embodiment of the present invention. As illustrated in FIG. 1, one or more financial institution systems 10 are operatively coupled, via a network 2, to one or more user computer systems 20, one or more account systems 30, and/or one or more third-party systems 40. In this way one or more users 4 (e.g., customers, potential customers, representatives, or the like) may utilize the one or more user computer systems 20 to access the financial wellness application 17 to determine the user's financial wellness. In some embodiments of the invention the one or more financial institution systems 10 and/or the one or more account systems 30 may store account applications, user profile information, and account information for the one or more users 4, and thus, the financial institution may access its own one or more financial institution systems 10 and/or one or more account systems 30 to retrieve information in order to determine the financial wellness of the users and/or provide actionable information to the users to improve the users' financial wellness. As such, personal characteristic information, financial wellness assessment question information, financial wellness assessment determination information, and information for the actionable items may be accessed or stored through applications for the one or more financial institution systems 10 and/or the one or more account systems 30. In still other embodiments, personal characteristic information, financial wellness assessment question information, financial wellness assessment determination information, and information for the actionable items may be accessed or stored through applications for the one or more third-party systems 40.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 1, the financial institution systems 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 14 may include functionality to operate one or more software programs based on computer-readable instructions 18 thereof, which may be stored in a memory device 16.

The processing device 14 uses the communication device 12 to communicate with the network 2 and other devices on the network 2, such as, but not limited to, the user computer systems 20, the account systems 30, third-party systems 40, or other like systems. As such, the communication device 12 generally comprises a modem, server, or other device for communicating with other devices on the network 2.

As further illustrated in FIG. 1, the financial institution systems 10 comprise computer-readable instructions 18 stored in the memory device 16, which in one embodiment includes the computer-readable instructions 18 of a financial wellness application 17 (e.g., financial wellness tool, or the like). In some embodiments, the memory device 16 includes a datastore 19 for storing data related to the financial institution systems 10, including, but not limited to, data created and/or used by the financial wellness application 17.

The financial wellness application 17 may be a tool, website, mobile device app, or the like that is use to gather information about a user and provide an indication to the user 4 of the user's financial wellness, which includes the user's financial situation, the user's day-to-day financial management, and the user's preparation for the future. The financial wellness application 17 may also provide tips, access articles or videos to provide to the user, suggest products to the user 4, and allow the user 4 to take actions to improve the user's 4 financial wellness.

As illustrated in FIG. 1, a user 4 may access the financial wellness application 17 through a user computer system 20. The user computer system 20 may be a desktop, laptop, tablet, mobile device (e.g., smartphone device), or any other type of computer that generally comprises a communication device 22, a processing device 24, and a memory device 26.

The processing device 24 is operatively coupled to the communication device 22, and the memory device 26. The processing device 24 uses the communication device 22 to communicate with the network 2 and other devices on the network 2, such as, but not limited to, the financial institution systems 10, the account systems 30, the third-party systems 40, and/or other systems. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the user 4.

As illustrated in FIG. 1, the user computer systems 20 may have computer-readable instructions 28 stored in the memory device 26, which in one embodiment includes the computer-readable instructions 28 of a web browser or another application 27 that allows the user 4 to access the financial wellness application 17 or receive information (e.g., wellness scores, actionable information, or the like) from the financial wellness application 17, or access or received information from other applications, such as account applications 37, third-party applications, or the like. In some embodiments, the memory device 26 includes a datastore 29 for storing data related to the client computer systems 20, including but not limited to data created and/or used by the web browser/application 27. The web browser/application 27 may be utilized by the user 4 to access the financial wellness application 17, or receive information from the financial wellness application 17, to view and/or access a financial wellness information (e.g., scores, wellness information, actionable information, or the like). The web browser may be an application that allows the user 4 to access websites over a distributed network of systems (e.g., servers), such as the Internet or an intranet. The application may also be a dedicated application for a computer or mobile device that allows the user 4 to access information over the distributed network of systems (e.g., servers), such as the Internet or an intranet.

As illustrated in FIG. 1, the account systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the financial institution systems 10, the user computer systems 20, third-party systems 40, and/or other systems. As such, the communication device 32 generally comprises a modem, server, or other device for communicating with other devices on the network 2.

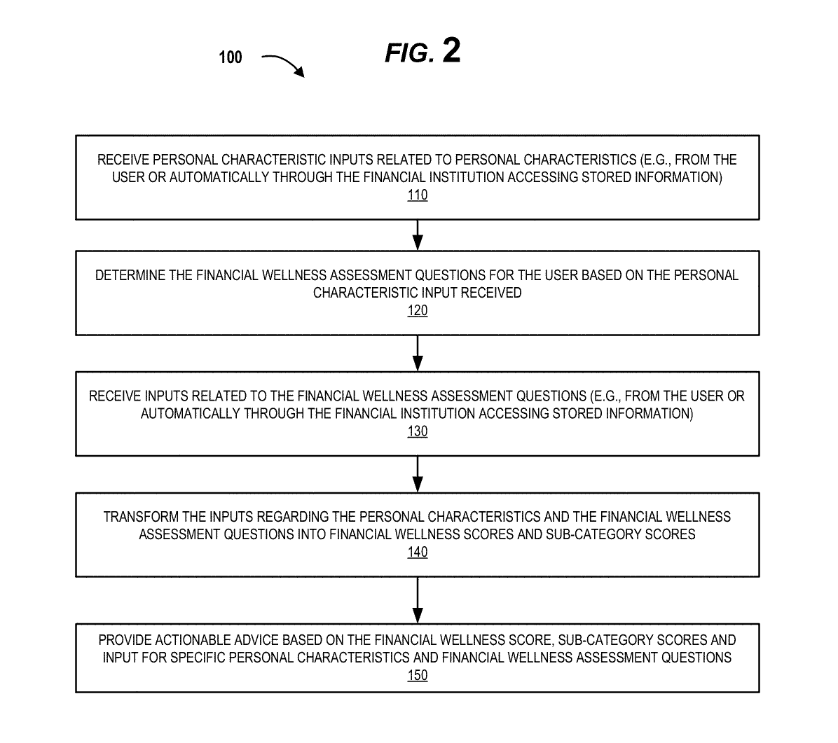

As further illustrated in FIG. 2, the account systems 30 comprise computer-readable instructions 38 stored in the memory device 36, which in one embodiment includes the computer-readable instructions 38 of account applications 37. In some embodiments, the memory device 36 includes a datastore 39 for storing data related to the account systems 30, including but not limited to data created and/or used by the account applications 37.

The account applications 37 may include information about the user's income, accounts, net worth, investments, personal user profile information (e.g., age, dependents, or the like). In some embodiments, the financial institution may access this information for the user 4, or the user 4 may access this information directly, in order to provide information to the financial wellness application 17 to determine the financial wellness of the user 4.

The third-party systems 40, or other financial institution systems (not illustrated) are operatively coupled to the financial institution systems 10, user computer systems 20, and account systems 30, through the network 2. The third-party systems 40 and/or other financial institution systems have devices the same as or similar to the devices described for the financial institution systems 10, the user computer systems 20, and the account systems 30 (e.g., communication device, processing device, memory device with computer-readable instructions, datastore, or the like). Thus, the third-party systems 40 and/or other financial institution systems communicate with the financial institution systems 10, the user computer systems 20, and the account systems 30, and/or each other in the same or similar way as previously described with respect to the financial institution systems 10, the user computer systems 20, and the account systems 30. The third-party systems 40 and/or the other financial institution systems, in some embodiments, provide additional information about the users 4, such as but not limited to user profile information, the user's assets and liabilities, the user's investments, or the like that stored by other financial institutions, which may be used for the financial wellness application, or the like.

In some embodiments of the invention one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the financial wellness application 17 may be stored on the user computer systems 20 in order to achieve the invention described herein (e.g., a financial wellness app stored on a mobile device of the user 4).

FIG. 2 illustrates a high level process flow for a financial wellness determination 100. As illustrated by block 110 in FIG. 1, the financial institution receives inputs related to personal characteristics of the user 4, such as but not limited to age, household income, household responsibility, loans, home ownership, accounts, or the like. The personal characteristic inputs may be received manually from the user 4 (e.g., customer, potential customer, representative of the financial institution, or the like) inputting the information, or received automatically from the financial institution accessing profile information and/or account information about the user 4 from stored information within account applications 37.

As illustrated by block 120 in FIG. 2, the financial institution determines the financial wellness assessment questions, from a plurality of financial wellness questions, to present to the user based on the personal characteristic input received. As such, specific questions may be presented or altered for presentation based on the input regarding the personal characteristics.

Block 130 in FIG. 2 illustrates that the financial institution receives inputs from the users 4 related to the financial wellness assessment questions. As with the personal characteristic input, the financial wellness assessment input may be manually received from the user 4, or at least some of the financial wellness assessment input may be automatically received, such as for example the financial wellness application 17 may access stored customer account information from the account systems 30.

FIG. 2 illustrates in block 140, that the inputs regarding the personal characteristics and the financial wellness assessment questions are transformed into a financial wellness score, category scores, and/or sub-category scores for different categories and sub-category.

Block 150 of FIG. 2 illustrates that based on the scores and/or specific inputs for specific financial wellness assessment questions and/or personal characteristics, when compared to threshold values for the scores and/or threshold inputs, the financial institution provides actionable advice to the user. The actionable advice may include financial tips, articles and videos, offers for products, or the like that will help to improve different aspects of the user financial wellness.

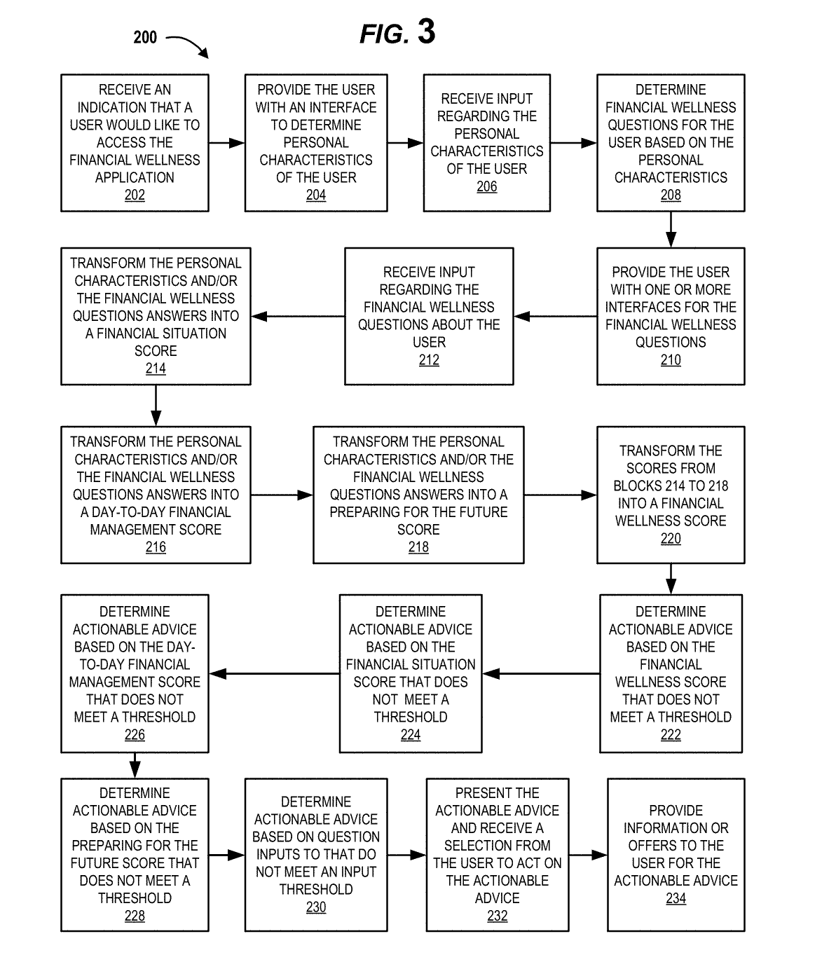

FIG. 3 illustrates a detailed process flow for a financial wellness determination and actionable advice determination process 200, in accordance with one embodiment of the invention. As illustrated by block 202 in FIG. 3, the financial institution receives an indication that a user would like to access the financial wellness application 17 in order to determine the user's financial wellness assessment. In some embodiments, this may occur through the user making a selection within a website or application on the user's computer systems 20. In other embodiments the user accesses the financial wellness application 17, through a representative of the financial institution through an in-person visit at a bank branch, over a video conference, over a communication through the Internet (e.g., chat, instant message, or the like), or the like.

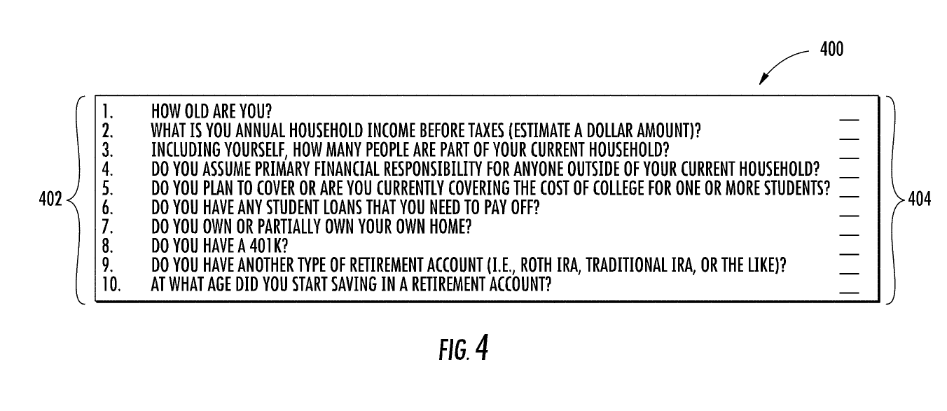

Block 204 illustrates that in response to receiving an indication that a user would like to access the financial wellness application 17, the financial institution presents the user 4 with one or more financial wellness interfaces that are used to provide the financial wellness assessment for the user 4. In one embodiment, the one or more financial wellness interfaces includes one or more personal characteristic questions that are presented to the user in one or more interfaces personal characteristic interfaces. As illustrated by the personal characteristic interface 400 in FIG. 4, the personal characteristic questions 402 may include, but are not limited to, 1) How old is the user; 2) What is the user's annual household income; 3) How many people are part of the current household; 4) Does the user assume primary financial responsibility for anyone outside of the current household; 5) Does the user plan to cover or is currently covering the cost of college for one or more students; 6) Does the user have any student loans that you need to be paid off; 7) Does the user own or partially own the home in which the user lives; 8) Does the user have a 401K?; 9) Does the user have another type of retirement account (i.e., Roth IRA, Traditional IRA, or the like); and 10) At what age did the user start saving in a retirement account? At least some of these personal characteristic questions 402, as well as others not specifically illustrated, may be utilized by the financial wellness application 17 to determine what financial wellness assessment questions should be presented to the user 4, to determine a financial wellness score for the user 4, and/or to determine financial wellness category scores, as will be discussed in further detail later. As such, in some embodiments of the invention only some of these personal characteristic questions may be presented to the user 4, and instead some of these personal characteristic questions may instead be included as financial wellness assessment questions.

As illustrated by block 206 the financial wellness application 17 receives input regarding the personal characteristics of the user 4. In some embodiments the personal characteristic input 404 may be received from the user 4 entering responses to the personal characteristic questions through the one or more financial wellness interfaces displayed on the user computer systems (e.g., a user laptop, mobile device, or the like). In other embodiments the financial wellness application 17 may access user profile information, account information, or other like information, for example, through information stored on the financial institution systems 10, account systems 30, and/or other financial institution systems. For example, with respect to the third-party systems 40, the financial institution may have partnerships with the third-party systems 40 and/or the user 4 may allow the financial institution to access the user's profile information and/or account information located on third-party systems 40. The user 4 may always be able to adjust any of the personal characteristic inputs received, which may or may not have been determined automatically.

Block 208 of FIG. 3 illustrates that after (or during) receiving the inputs for the personal characteristics, the financial wellness application 17 determines the financial wellness questions 502 from a plurality of financial wellness questions to display to the user based on the inputs received for the personal characteristics. For example, if the input related to the user's household indicates only the user is a part of the household and the user does not have any dependents, then questions related to supporting dependents may not be displayed to the user 4. The plurality of financial wellness questions may be stored within the financial institution systems 10, or other systems described herein.

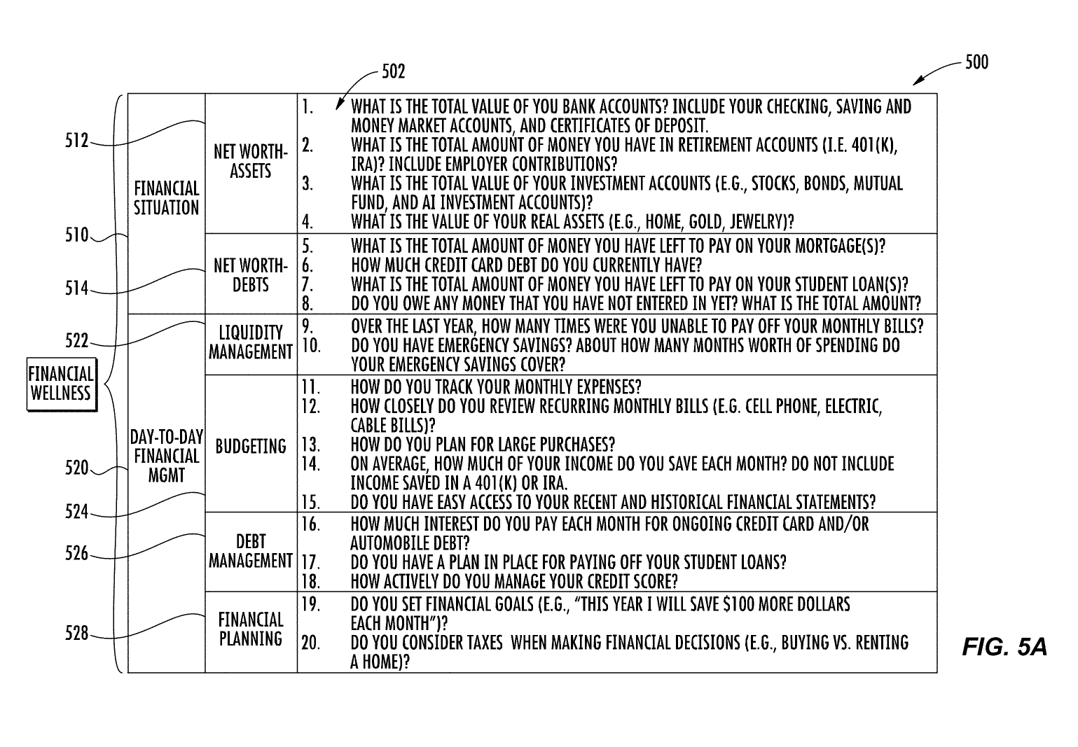

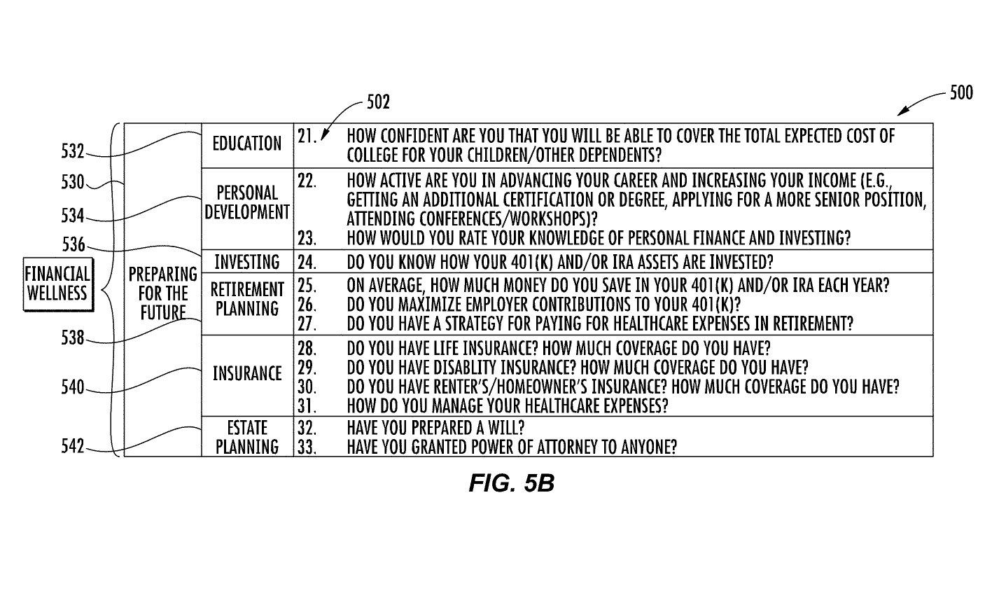

After the financial wellness application 17 determines the financial wellness questions 502 to present to the user 4, it presents the user with one or more financial wellness assessment interfaces 500 that include the financial wellness questions 502, as illustrated by block 210 in FIG. 3. In one embodiment of the invention the ultimate financial wellness score may be broken down into three categories related to a financial situation category 510, a day-to-day financial management category 520, and a preparation for the future category 530, as illustrated in FIGS. 5A and 5B. The financial situation category 510 may be related to a measure of the value of everything that the user 4 owns (e.g., net worth). The financial situation category 510 may further comprise a net worth-assets 512 sub-category and a net-worth debts 514 sub-category. The day-to-day financial management category 520 may be related to a measure of how well the user handles the user's current finances. As illustrated in FIGS. 5A and 5B, the day-to-day financial management category may include sub-categories that relate to liquidity management 522, budgeting 524, debt management 526, and financial planning 528. The preparation for the future category may be related to measuring how well the user plans for long-term financial needs. FIGS. 5A and 5B illustrate that the preparation for the future category 530 may include sub-categories that relate to education 532, personal development 534, investing 536, retirement planning 538, insurance 540, and estate planning 542.

FIGS. 5A and 5B illustrate examples of the financial wellness questions that may be presented to the user 4 based on the inputs related to the personal characteristics, in accordance with one embodiment of the invention. As illustrated in FIGS. 5A and 5B, the net worth—assets sub-category 512 of the financial situation category 510 may include financial wellness questions related to 1) What is the total value of the user's bank accounts, including checking, savings, and money market accounts, and certificates of deposit; 2) What is the total amount of money the user has in retirement accounts (i.e., 401(k), IRA), including employer contributions; 3) What is the total value of the user's investment accounts (e.g., stocks, bonds, mutual fund, and AI investment accounts); and 4) what is the value of the user's real assets (e.g., home, gold, jewelry, property, or the like)? As further illustrated in FIGS. 5A and 5B, the net worth—debts sub-category 514 of the financial situation category 510 may include financial wellness questions related to 5) What is the total amount of money the user has left to pay on the mortgage; 6) How much credit card debt does the user currently have; 7) What is the total amount of money the user has left to pay on student loan(s); 8) Does the user owe any money that the user has not yet entered, and if so, what is the total amount?

FIGS. 5A and 5B further illustrate that the liquidity management sub-category 522 of the day-to-day financial management category 520 may include financial wellness questions related to 9) Over the last year, how many times has the user been unable to pay off monthly bills; and 10) Does the user have emergency savings, and if so how many months of spending would the user's emergency savings cover? The budgeting sub-category 524 of the day-to-day financial management category 520 may include financial wellness questions related to 11) How does the user track monthly expenses; 12) How closely does the user review recurring monthly bills (e.g., cell phone, electric, cable bills); 13) How does the user plan for large purchases; 14) On average, how much of the users income does the user save each month, not including income saved to a 401k or IRA; and 15) Does the user have easy access to the user's recent and historical financial statements? FIGS. 5A and 5B further illustrate that the debt management sub-category 526 of the day-to-day financial management category 520 may include financial wellness questions related to 16) How much interest does the user pay each month for ongoing credit card and/or automobile debt; 17) Does the user have a plan in place for paying off student loans; 18) How actively does the user manage the user's credit score? FIGS. 5A and 5B further illustrate that the financial planning sub-category 528 of the day-to-day financial management category 520 may include financial wellness questions related to 19) Does the user set financial goals (e.g., “This year I will save $100 more dollars each month”); and 20) Does the user consider taxes when making financial decisions (e.g., buying vs. renting a home)?

FIGS. 5A and 5B further illustrate that the education sub-category 532 of the preparation for the future category 530 may include financial wellness questions related to 21) How confident is the user that the user will be able to cover the total expected cost of college for the user's children/other dependents? FIGS. 5A and 5B further illustrate that the personal development sub-category 534 of the preparation for the future category 530 may include financial wellness questions related to 22) How active is the user in advancing the user's career and increasing the user's income (e.g., getting an additional certification or degree, applying for a more senior position, attending conferences/workshops); and 23) How would the user rate the user's knowledge of personal finance and investing? FIGS. 5A and 5B further illustrate that the investing sub-category 536 of the preparation for the future category 530 may include financial wellness questions related to 24) Does the user know how the user's 401(k) and/or IRA assets are invested? FIGS. 5A and 5B further illustrate that the retirement planning sub-category 538 of the preparation for the future category 530 may include financial wellness questions related to 25) On average, how much money does the user save in the user's 401(k) and/or IRA each year; 26) Does the user maximize employer contributions to the user's 401(k); and 27) Does the user have a strategy for paying for healthcare expenses in retirement? FIGS. 5A and 5B further illustrate that the insurance sub-category 540 of the preparation for the future category 530 may include financial wellness questions related to 28) Does the user have life insurance, and if so how much coverage does the user have; 29) Does the user have disability insurance, and if so how much coverage does the user have; 30) Does the user have renter's insurance or homeowner's insurance, and if so how much coverage does the user have; and 31) How does the user manage the user's healthcare expenses? FIGS. 5A and 5B further illustrate that the estate planning sub-category 542 of the preparation for the future category 530 may include financial wellness questions related to 32) Has the user prepared a will; and 33) Has the user granted power of attorney too anyone?

It should be understood that the questions listed in FIGS. 5A and 5B, and explained above, may or may not be presented to the user 4, may change, may be presented as a variation of the questions, or may be replaced by other questions, or the like based on the input received for the user's personal characteristics. In still other embodiments of the invention some of the financial wellness questions displayed and discussed herein as being related to a specific category or sub-subcategory may instead be utilized in other categories or sub-categories, or may be utilized in multiple categories and/or sub-categories. Moreover, in some embodiments of the invention the personal characteristics may also be included as a financial wellness question.

As illustrated by block 212 in FIG. 3, the financial institution application 17 receives financial wellness input for the financial wellness questions 502 presented to the user 4. In some embodiments the financial wellness input may be received from the user 4 entering responses to the financial wellness questions 502, entered through the one or more financial wellness interfaces 500 displayed on the user computer systems 20 (e.g., a user laptop, mobile device, or the like). In other embodiments, the financial wellness application 17 may access the user profile information, account information, or the like, for example, through information stored on the financial institution systems 10, account systems 30, and/or other third-party systems 40 or other financial institution systems. For example, with respect to the third-party systems 40, the financial institution may have partnerships with the third-parties and/or the user 4 may allow the financial institution to access the user's profile information and/or account information located on third-party systems 40. The user 4 may always be able to adjust any of the financial wellness input determined automatically.

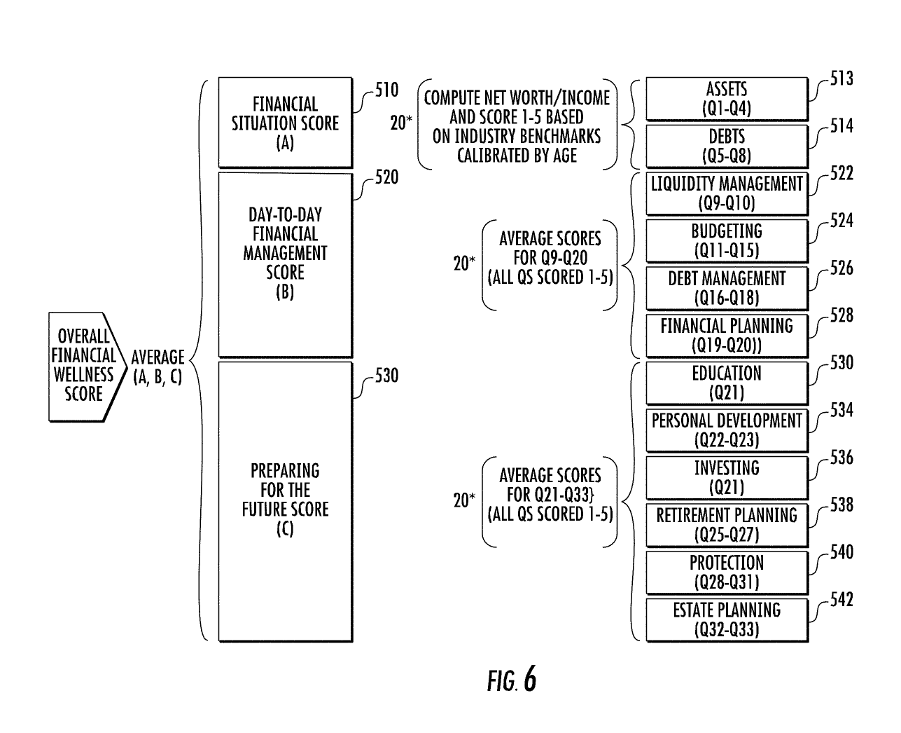

Block 214 of FIG. 3 illustrates that the financial institution application 17 (e.g., the financial institution through the application, or another system or application) transforms the financial wellness question input and/or the personal characteristics input) into a financial situation score. As illustrated by FIG. 6, in one embodiment of the invention the financial situation score may be determined by determining the user's net worth based on the net worth—assets sub-category 512 of financial wellness questions 502, and the net worth—debts sub-category 514 of financial wellness questions 502. After the net worth is calculated, the net worth may be divided by the household income (e.g., the household income determined from the personal characteristic input received). The score for user's financial situation category 510 may be based on both the calculation of the net worth as a percentage of income and the age of the user (e.g., the age based on the personal characteristic input received). As a general example, the younger the user 4 the less the net worth as a percentage of income is needed to achieve a higher score, when compared with users 4 that are older. In some embodiments of the invention, the financial situation score may be based on a scale of 1 to 5, which is then multiplied by 20 in order to scale the score to 100.

As illustrated by block 216 in FIG. 3, the financial institution application 17 (e.g., the financial institution through the application, or another system or application) transforms the financial wellness questions 502 and/or the personal characteristics 402 into a day-to-day financial management score. As illustrated by FIG. 6 the day-to-day management score may be determined in one embodiment by scoring the answers to each on the questions within the sub-categories of the day-to-day management category 520 and averaging the scores for the each of the financial wellness questions 402 equally. In some embodiments of the invention, the financial wellness input for each of the financial wellness questions 402 for the day-to-day management category 520 are scored on a scale of 1 to 5, averaged, and then multiplied by 20 in order to scale the score to 100. In other embodiments of the invention the scores for each of the individual financial wellness questions 502 within the day-to-day management category 520 or sub-categories may be weighted differently.

Block 218 in FIG. 3 illustrates that the financial institution application 17 (e.g., the financial institution through the application, or another system or application) transforms the financial wellness questions 502 and/or the personal characteristics 402 into a preparing for the future score. As illustrated by FIG. 6 the preparing for the future score may be determined in one embodiment by scoring the answers to each of the questions within the sub-categories of the preparing for the future category 530, and averaging the scores for the each of the financial wellness questions 502 equally. In some embodiments of the invention, the financial wellness input for each of the financial wellness questions 502 for the preparation for the future category 530 are scored on a scale of 1 to 5, averaged, and then multiplied by 20 in order to scale the score to 100. In other embodiments of the invention the scores for each of the individual financial wellness questions within the preparing for the future category 530 or sub-categories may be weighted differently.

As illustrated by block 220 in FIG. 3, the financial situation score, the day-to-day financial management score, and the preparing for the future score from blocks 214 to block 218 are transformed into an overall financial wellness score. In some embodiments of the invention the categories of the financial wellness score have already been scaled to 100, and thus, are weighted equally and averaged in order to determine the financial wellness score, as illustrated by FIG. 6.

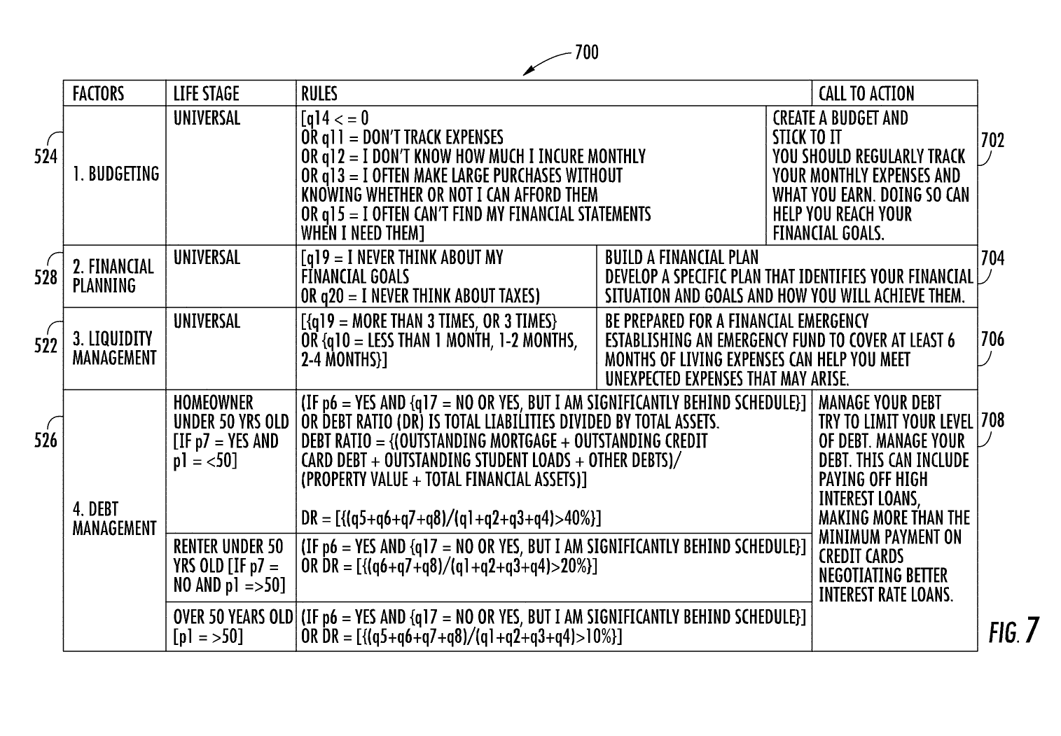

Block 222 of FIG. 3 illustrates that when the financial wellness score, category scores, sub-category scores, or specific input for specific questions does not meet one or more threshold scores (or specific threshold scores for financial wellness question inputs, combinations of threshold scores for multiple financial wellness question inputs, and/or combinations with specific personal characteristic inputs, which is discussed in further detail regarding block 230 and FIGS. 7 through 9) actionable advice is provided to the user 4. In some embodiments of the invention, the actionable advice may include information about what the user should do to improve the user's financial wellness for specific categories, sub-categories, and financial wellness questions within the sub-categories. The information may include financial tips, articles or video related to improving financial wellness, and/or offers from the financial institution related to products that may help to improve the user's financial wellness.

Block 224 of FIG. 3 illustrates that when the financial situation score does not meet one or more threshold scores, actionable advice is provided to the user 4 as discussed throughout. Block 226 of FIG. 3 illustrates that when the day-to-day financial management score does not meet one or more threshold scores, actionable advice is provided to the user 4 as discussed throughout. Block 228 of FIG. 3 illustrates that when the preparing for the future score does not meet one or more threshold scores, actionable advice is provided to the user 4 as discussed throughout.

As illustrated by block 230 of FIG. 3 and FIGS. 7-9, actionable advice may be provided to the user 4 when specific scores for financial wellness question inputs, combinations of threshold scores for multiple financial wellness question inputs, and/or combinations with specific personal characteristic inputs do not meet threshold rules and/or scores. As illustrated by FIGS. 7-9, in some embodiments of the invention each of the sub-categories and/or each of the financial wellness questions 502 and/or personal characteristic questions 402 have rules, which illustrate that when the financial wellness input or personal characteristic input does not meet a particular threshold response for the financial wellness questions 502 and/or personal characteristic questions 402, actionable advice may be presented to the user 4. As illustrated in FIG. 7, with respect to the budgeting sub-category 524, the actionable advice may include regularly tracking the user's monthly expenses and what the user earns. As such, as illustrated in FIG. 7, if the user 4 answers questions 11-15 in a specific way, actionable budgeting advice 702 may be presented to the user 4. For example, articles related to budgeting, budgeting calculators and/or tools, budgeting audio or video tutorials, other like budgeting information, and/or paid for free subscriptions to each of these may be presented to the user 4 to improve the user's budgeting.

As further illustrated in FIG. 7, with respect to the financial planning category 528, the actionable advice may include developing a specific plan that identifies the user's financial situation and goals and how the user 4 will achieve the goals. As such, as illustrated in FIG. 7, if the user 4 answers questions 19 or 20 in a specific way, actionable financial planning advice 704 may be presented to the user 4. For example, articles or videos related to financial planning, financial planning tools like savings estimators and cost of living estimators, other like financial planning tools, and/or paid for free subscriptions to each of these may be presented to the user 4 to improve the user's financial planning.

As illustrated in FIG. 7, with respect to the liquidity management category 522 (otherwise described as the emergency savings category), the actionable advice may include establishing an emergency fund to cover at least six (6) months of living expenses. As such, as illustrated in FIG. 7, if the user 4 answers questions 9 and 10 in a specific way, actionable liquidity management advice 706 may be presented to the user 4. For example, articles or videos related to creating an emergency fund, emergency fund tool calculators, invitations to open savings, investment, and/or cash management accounts, or other like other like liquidity management information, and/or paid for free offers for each of these may be presented to the user 4 to improve the user's liquidity management.

As illustrated in FIG. 7, with respect to the debt management category 526, the actionable advice may include providing suggestions for limiting the user's level of debt and managing the user's debt, which may including paying off high interest rate loans, making more than the minimum payment on credit cards negotiating better interest rate loans, or the like. As such, as illustrated in FIG. 7, if the user 4 answers the personal characteristic question 7 (e.g., home ownership), 1 (e.g., age), 6 (e.g., student debt), and financial wellness question 17 (e.g., paying off student loan) or has a specific debit ratio calculated from specific questions, then different actionable debt management advice 708 may be presented to the user 4. For example, articles and videos related to managing debt, financial credit worthiness, interest rates, and liabilities, debt to income ratio calculator assessments, other like debt management information, and/or paid or free subscriptions to each of these may be presented to the user 4 to improve the user's debt management. In other embodiments of the invention, the financial institution may also provide financial tools, such as debt consolidation, lower interest rate loans, or the like the help the user 4 manage the user's debt.

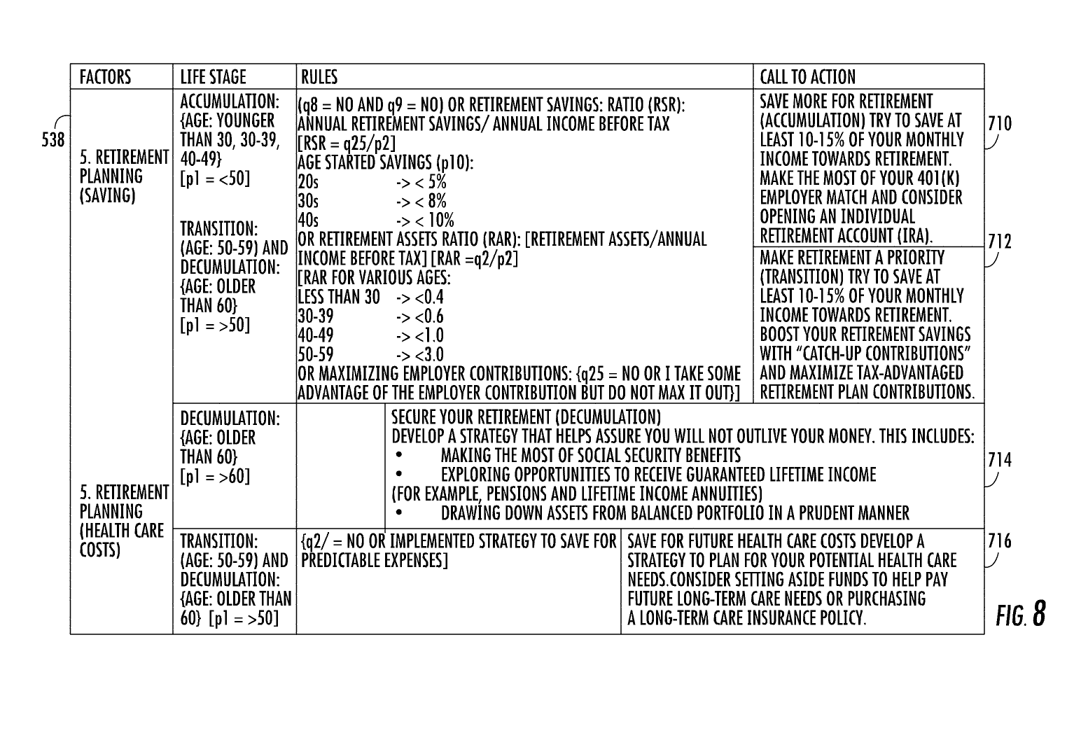

As illustrated in FIG. 8, with respect to retirement planning category 538, the actionable advice may include advice for accumulation (e.g., younger than 50), transition (e.g., between 50 and 60), or decumulation (e.g., greater than 60) of retirement assets. The actionable accumulation advice 710 may include suggesting trying to save at least 10-15% of monthly income towards retirement, making the most of the user's 401(k) employer match, and consider opening an individual retirement account (IRA). As such, as illustrated in FIG. 8, if the user 4 answers questions 8 and 9 in a specific way or has a specific retirement savings ratio identified by question 25 and personal characteristic question 2, actionable accumulation advice 710 may be presented to the user 4. The actionable transition advice 712 may also include suggesting trying to save at least 10-15% of monthly income towards retirement, and boosting the user's retirement savings with catch-up contributions and maximize tax-advantage retirement plan contributions. As such, as illustrated in FIG. 8, if the user 4 answers question 10 in a specific way or has a retirement asset ratio identified by question 2 and personal characteristic question 2, actionable transition advice 712 may be presented to the user 4. For example, articles or video related to retirement savings, retirement planning tools for determining a retirement number or investment calculators, opening or funding retirement accounts, other like retirement planning information, and/or paid or free subscriptions to each of these may be presented to the user 4 to improve the user's retirement planning.

As illustrated in FIG. 8, with respect to decumulation retirement planning, the actionable advice may include developing a strategy that helps assure the user 4 will not outlive the user's money. This may include identifying social security benefits, exploring opportunities to receive guaranteed lifetime income, and/or drawing down assets from a balanced portfolio in a prudent manner. As such, as illustrated in FIG. 8, if the user 4 answers questions 9 and 10 in a specific way, actionable decumulation advice 714 may be presented to the user 4. For example, articles or videos related to retirement pitfalls, boosting retirement savings and managing retirement accounts, social security benefits, annuity payments, drawdown strategies, other like retirement planning information, and/or paid or free subscriptions to each of these may be presented to the user 4 to improve the user's retirement planning. The financial institution may also present retirement annuity offers, or other retirement offers to the user 4.

As illustrated in FIG. 8, with respect to the transition for retirement planning, the actionable advice may include suggesting development of a strategy to plan for the user's potential health care needs, and consider setting aside funds to help pay future long-term care needs or purchasing a long-term care insurance policy. As such, as illustrated in FIG. 8, if the user 4 answers question 27 in a specific way, actionable health care advice 716 may be presented to the user 4. For example, articles or videos related to preparing for retirement health care cost, other like health care information, product offers related to health care costs, and/or paid for free offers to each of these may be presented to the user 4 to improve the user's planning for retirement.

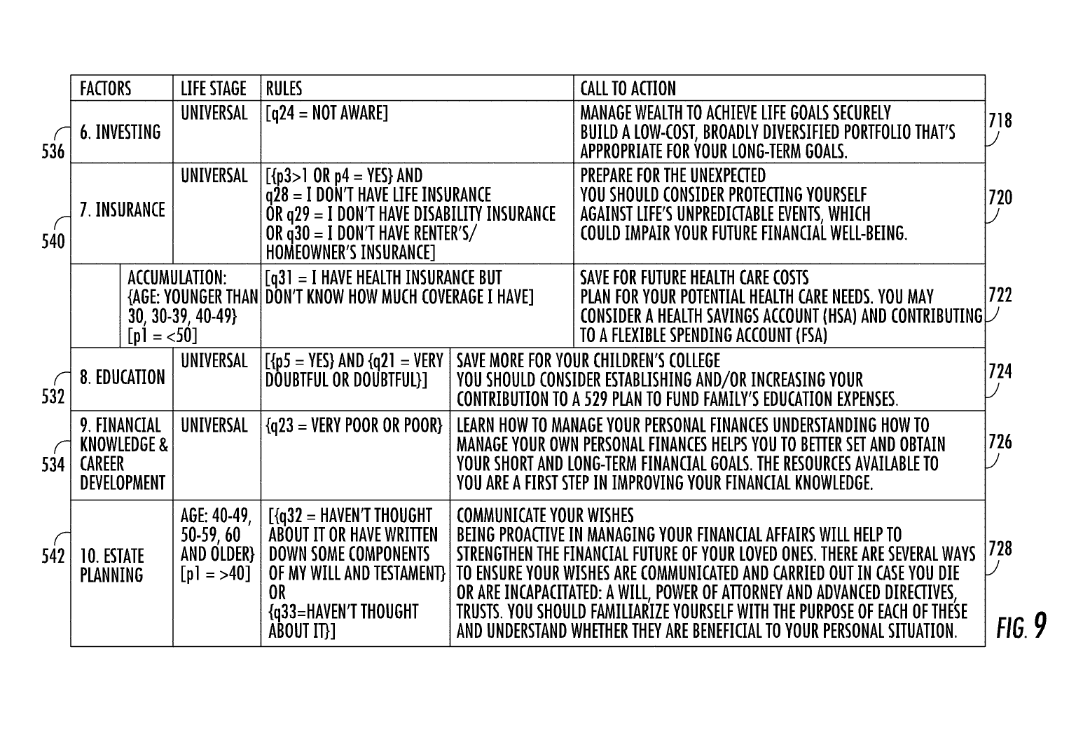

As further illustrated in FIG. 9, with respect to the investing sub-category 536, the actionable advice may include suggesting building a low-cost, broadly diversified portfolio that is appropriate for the user's long-term goals. As such, as illustrated in FIG. 9, if the user 4 answers question 24 in a specific way, actionable investing advice 718 may be presented to the user 4. For example, articles or videos related to asset allocation, stocks, exchange-traded funds, mutual funds, and bonds, calculators for determining how much to invest, offers for online brokerage accounts, and/or paid or free subscriptions to each of these may be presented to the user 4 to improve the user's investing.

As further illustrated in FIG. 9, with respect to the insurance sub-category 540, the actionable advice may universal advice or based on the user 4 being a specific age (e.g., less than 50 years old). With respect to universal advice, the actionable advice may include considering to protect yourself against life's unpredictable events, which could impair the future financial well-being of the user 4. As such, as illustrated in FIG. 9, depending on personal characteristic questions 3 and 4 for the user 4, and how the user 4 has answered questions 28-30, actionable insurance advice 720 may be presented to the user 4. For example, articles or videos related to insurance education for belongings, assets, and health, insurance amounts and premiums, other like insurance information, offers for insurance products, and/or paid or free subscriptions to each of these may be presented to the user 4 to improve the user's insurance planning. With respect to health insurance based on the user's age, the actionable advice may include planning for the user's health care needs, by considering a health savings accounts (HAS) and contributing to a flexible spending account (FSA). As such, as illustrated in FIG. 9, depending personal characteristic 1 (e.g., user age) for the user 4, and how the user 4 has answered question 31, actionable health insurance advice 722 may be presented to the user 4. For example, articles or videos related to paying for current and retirement health care, other like health insurance information, offers for health insurance products or spending accounts, and/or paid or free subscriptions to each of these may be presented to the user 4 to improve the user's health insurance planning.

As further illustrated in FIG. 9, with respect to the education sub-category 532, the actionable advice may include suggesting that the user should establish and/or increase the user's contribution to a 529 plan to fund education expenses. As such, as illustrated in FIG. 9, depending on the personal characteristic question 5 (e.g., cover depending cost of college) and the user's answer to question 21, the actionable education advice 724 may be presented to the user 4. For example, articles or videos related to strategies for saving for college, using 529 plans, financial aid packages, scholarships, comparing college investment products, calculators for determining college costs, other education information, offers for education investments, and/or paid or free subscriptions to each of these may be presented to the user 4 to improve the user's education planning.

As further illustrated in FIG. 9, with respect to the personal development sub-category 534 (otherwise described as career development), the actionable advice may include helping the user 4 to manage the user's own personal finances to help the user to better set and obtain short and long term financial goals, and providing resources to improve financial knowledge. As such, as illustrated in FIG. 9, depending on the user's answer to question 23, the actionable personal development advice 726 may be presented to the user 4. For example, articles or videos related to any of the various actionable advice topics discussed herein may be presented to the user 4.

As further illustrated in FIG. 9, with respect to the estate planning sub-category, the actionable advice may include suggesting that the user 4 should be proactive in managing financial affairs to strengthen the financial future of the user's family, such as by preparing a will, power of attorney, advanced directives, and trusts. As such, as illustrated in FIG. 9, depending on the personal characteristic 1 (e.g., age) and the user's answer to questions 32 and 33, the actionable estate planning advice 728 may be presented to the user 4. For example, articles or videos related to wills, power of attorneys, advanced directives, and trusts, estate tax calculators, other estate planning information, offers for estate planning products, and/or paid or free subscriptions to each of these may be presented to the user 4 to improve the user's estate planning.

In some embodiments of the invention, the user 4 may select one or more of the types of actionable advice described herein in order to view tips, articles, video, applications, calculators, or the like to identify information related to one or more of the categories, sub-categories, financial wellness questions, and/or personal characteristic what may help to improve the user's financial wellness. In still other embodiments of the invention the user 4 may select one or more products presented to the user 4 in order to improve the financial wellness of the user 4. For example, the financial institution may offer, and the user 4 may accept, a low interest rate loan that may be used to pay off higher interest rate loans. Other financial products may be presented to the user 4, such as investment accounts, meetings with advisors, checking accounts, savings accounts, trust management, accounting services, or other types of financial products. The users may be able to utilize these products in order to improve the users' financial wellness.

In some embodiments, the financial institution may utilize the financial wellness assessment of the present invention to better serve the needs of the user 4. For example, without having the information provided by the user 4 for the personal characteristics and/or financial wellness questions, the financial institution may present products to the user 4 without having an idea of what the user 4 actually needs to improve the user's financial wellness. As such, the financial wellness assessment of the present invention provides information to the financial institution that helps to target the specific areas in which the user 4 may be deficient with respect to financial wellness, and allows the financial institution to suggest products to the user 4 to improve any deficiencies in the user's financial wellness.

As discussed above, a financial wellness application may provide an overview of the financial well-being of users (e.g., customers of a financial institution, or the like). The financial wellness of the users may be determined by identifying personal characteristics of the users regarding background information about the users and the users' households. The personal characteristics may be determined by the users answering personal characteristic questions or by the finial institution automatically accessing user profile information or user account information to identify the personal characteristics. Based on a user's personal characteristics, financial wellness questions are determined from a plurality of financial wellness questions to present to the user. The user provides financial wellness input regarding the financial wellness questions. The financial wellness input is transformed into a financial situation assessment, day-to-day management assessment, and preparation for the future assessment, which are transformed into an overall wellness score. Moreover, the financial wellness input for the one or more financial wellness questions may also be compared against financial wellness thresholds. As such, when the user's financial wellness input fails to meet the threshold values it may trigger the display of actionable advice for the user. The actionable advice may include suggestions for the user to improve the user's financial wellness, articles related to tips for managing expenses, savings, and investments, and proposed product (e.g., financial services, or the like) offers that may help improve the user's wellness score and the user's management of the user's finances.

When the user has taken one or more actions corresponding to the actionable advice and has improved the overall wellness and/or intelligence score, a recommended product offer may be presented to the user. In some cases, one or more problems associated with the user are predicted and a stress test is performed. The stress test is configured to test the user's ability to handle the predicted one or more problems and results in a stress score. In response to the stress score moving past a threshold, second actionable advice may be presented to the user. The second actionable advice is configured to improve the user's ability to handle the predicted one or more problems.

In other words, the system evaluates the users financial information and comments from a questionnaire and creates a financial wellness score. The system also determines a user's financial acumen and level of knowledge regarding financial concepts and generates a financial intelligence score. Using the financial wellness score and the financial information, the system predicts potential issues with the person's finances and/or potential changes or products that the user could do/buy/enact to increase their financial wellness. The system also tests the user's competence regarding the potential issue, change, or product. If the user's score in this area is low, the system systematically feeds information to the user regarding the issue, change, or product to increase the user's intelligence in the area. Once the user has a high enough intelligence score, the system prompts the user to address the issue, change, or product. The system could send articles, alerts, calendar reminders etc. associated with the issue, change, or product. As an example, if a user or the user's child is close to graduation, the system could recognize this and begin to educate the user to boost their intelligence score. It could prompt them of deadlines to submit financial aid applications, take entrance exams, etc.

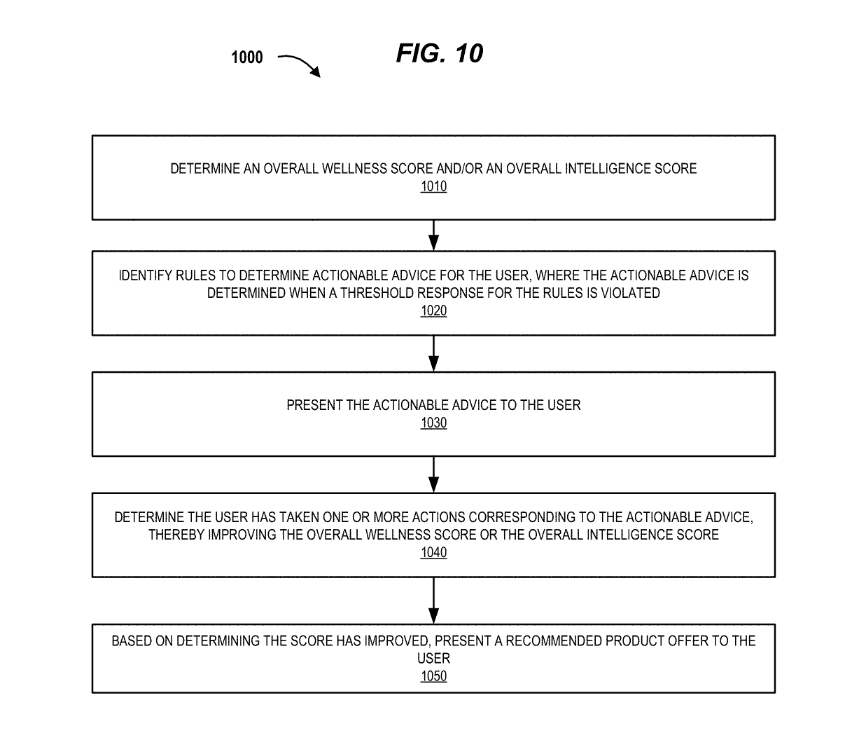

Referring now to FIG. 10, a method 1000 for intelligence assessment and action triggering is illustrated. The first step, as represented by block 1010 is to determine an overall wellness score and/or an overall intelligence score associated with the user. One or both these scores may be determined based on one or more of the methods discussed elsewhere herein. The next step, represented by block 1020, is to identify rules to determine actionable advice for the user. The actionable advice is determined when a threshold response for the rules is violated. Next, as represented by block 1030, embodiments present the actionable advice to the user. Then, embodiments determine the user has taken one or more actions corresponding to the actionable advice, thereby improving the overall wellness score and/or the overall intelligence score, as represented by block 1040. Finally, embodiments present a recommended product offer (and/or tips, advice or the like) to the user based on determining the score(s) has/have improved, as represented by block 1050.

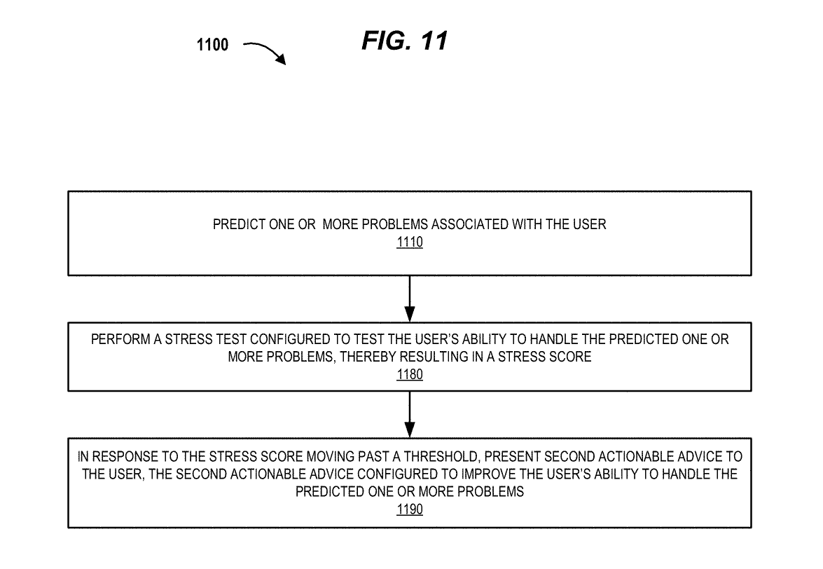

Referring now to FIG. 11, another method 1100 for intelligence assessment and action triggering is illustrated. The first step, represented by block 1110, is to predict one or more problems associated with the user. The next step, represented by block 1120, is to perform a stress test configured to test the user's ability to handle the predicted one or more problems, thereby resulting in a stress score. Finally, as represented by block 1130, the next step is to present second actionable advice to the user. The second actionable advice is configured to improve the user's ability to handle the predicted one or more problems in response to the stress score moving past a threshold.

Various embodiments of the financial or overall intelligence score may be based on financial acumen of the user and/or the user's level of knowledge. One or both of these scores may be used as inputs to a system that predicts problems, identifies appropriate products and/or tries to improve the user's financial wellness and/or financial intelligence.

In various embodiments, the user's competence regarding potential changes to their portfolio such as new products, accounts or the like may be tested. If the results are low, then specific educational information may be pushed to the user so that the user can improve his or her competence level or score. This may also be referred to as the intelligence score or the intelligence score for a particular focus area. Once the competence score improves, as a result of the educational materials provided to the user, then embodiments of the invention may move forward with solving one or more identified problems, proposing one or more new products or the like. In some cases, embodiments prompt the user regarding deadlines for submitting applications for new products that they have “qualified for” based on raising the user's intelligence score. Given a particular user score or parameters associated with the user (e.g., the user's net worth, number and/or type of products owned, etc.), embodiments of the invention can vary the type of stress test provided to the user. For example, if the user has a high net worth and multiple products, the stress test may be more stringent than if the user has a low net worth and/or a low number of products. In some cases, the stress test includes testing related to the resilience of the user to withstand changes in markets or the like. For example, the resilience testing may relate to retaining versus using an emergency fund or insurance, selling investments in a market downturn and/or the like.

Determining the user's intelligence as it relates to a particular product, problem or the like may be important before allowing the user to have access to the product or remedy the problem.

In some embodiments, a user interface provides a representation of the wellness score and/or the intelligence score to the user and enables the user to track changes in the score(s). In some embodiments, the interface provides a “gamification” of the score(s) and provides incentives for the user to review relevant literature, take additional tests and/or the like in order to improve the user's score(s). Such a gamification of the interface provides additional incentive for the user to return to the interface, and therefore, improve the score(s).

In some embodiments, the interface is configured to initiate communication to the user certain times of year. This may be based on information known about the user based on the user's relationship with the financial institution and/or the user's responses to questionnaires or the like. Embodiments motivate people to move past their fears and inaction inertia to solve problems over time by engaging the application over time.

In various embodiments, the financial acumen or intelligence score may be based on a quiz. The quiz may pull from current events to determine its questions. Information may be gathered on the users, such as their level of education, in order to establish a starting point for the quiz. The quiz may include multiple portions configured to correspond to certain topic areas, products, problems or the like. In some embodiments, each portion of the quiz may have an individual score and may have one or more associated actions the user may take in order to improve each individual score.

In various embodiments of the invention, the system provides a user an opportunity to achieve different tiers of access. For example, in one configuration, the user may gain access to: (1) features and/or functions (such as functions within an online banking application and/or mobile application), (2) tools that assist the user to “stay on track” to meet one or more goals, and/or (3) a product offering. In some embodiments, each of these three (or more or fewer) tiers are accessed by the user as the user achieves certain metrics and/or thresholds such as maintaining a threshold total balance or reading a threshold number of articles. The tiers may be accessed sequentially, that is, one at a time as certain metrics are achieved or may be accessed out of order if plausible based on the requirements for accessing a particular tier.

Some embodiments of the invention involve performing a “stress test” on the user. In some situations it may be difficult to predict certain circumstances, such as those influenced by one or more market(s), but it may be possible to ascertain how well the user is prepared for various events. For example, does the user have in place appropriate insurance for different potential scenarios. The stress test may also take into consideration certain goals of the user and predict whether the user will or will not meet the goal or the likelihood that the user will meet the goal. In some embodiments, the stress test may be considered an exposure test or comfort test in the sense that it considers how protected from certain contingencies the user has become through exposure reduction measures such as insurance or savings. As the user improves his or her exposure test metric, then the user may achieve “soft” benefits (or first tier benefits) such as showing their financial health improving through gamification elements such as graphics or other gaming rewards. As the user improves his or her exposure test metric further, then the user may achieve “hard” benefits (or second tier benefits) such as receiving preferred rewards, offers and/or the like.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for transforming user information into a determination of the overall wellness and/or overall intelligence of a user and triggering one or more actions configured to improve the overall wellness and/or overall intelligence of the user, the system comprising:
one or more memory devices having computer readable program code store thereon; and
one or more processing devices operatively coupled to the one or more memory devices, wherein the one or more processing devices are configured to execute the computer readable program code to:
based on user information, determine an overall wellness score and/or an overall intelligence score;
identify one or more rules from a plurality of rules for one or more of the wellness questions or the personal characteristic questions, wherein the one or more rules are used to determine actionable advice for the user, wherein the actionable advice is determined when a threshold response for the one or more rules is violated by the wellness assessment inputs or the personal characteristic inputs, and wherein the plurality of rules are stored on one or more servers;
present the actionable advice to the user on the user interface of the user device, wherein the actionable advice comprises tips, articles, or offers associated with the one or more rules that were violated by the wellness assessment inputs or the personal characteristic inputs, wherein the actionable advice is related to improving the overall wellness score of the user, wherein the actionable advice is stored on one or more servers, and wherein the actionable advice comprises tips, articles, or offers that are identified from third-party systems or one or more institution systems;
determine that the user has taken one or more actions corresponding to the actionable advice, thereby improving the overall wellness score or the overall intelligence score;
based on determining that the overall wellness score or the overall intelligence score has improved, present a recommended product offer to the user.

2. The system of claim 1, wherein determining the financial wellness score comprises:
presenting personal characteristic questions to the user, wherein the personal characteristic questions comprise financial history information about the user and the user's household, and wherein the personal characteristic questions are presented to the user through a user interface on a user device;
receiving personal characteristic inputs in response to the personal characteristic questions;
determining financial wellness assessment questions to present to the user from a plurality of financial wellness assessment questions, wherein the financial wellness assessment questions are determined based on the personal characteristic inputs received for the personal characteristics questions, wherein the financial wellness assessment questions relate to the user's financial situation, the user's day-to-day financial management, and the user's preparation for the future, and wherein the plurality of financial wellness assessments questions are stored on one or more servers;
presenting the financial wellness assessment questions to the user, wherein the financial wellness assessment questions are presented to the user on the user interface of the user device;
receiving financial wellness assessment inputs from the user in response to the financial wellness assessment questions, wherein the financial wellness assessment inputs are received from the user through the user interface on the user device;
transforming the financial wellness assessments inputs from the user into a financial situation score that measures a value of the user's net worth, a day-to-day financial management score that measures how the user handles current finances, and a preparing for the future score that measures how the user plans for long-term financial needs; and
transforming the financial situation score, the day-to-day financial management score, and the preparing for the future score into an overall financial wellness score.

3. The system of claim 2, wherein the personal characteristic inputs are received automatically through accessing user profile information or user account information stored on the one or more financial institution systems.

4. The system of claim 2, wherein the personal characteristic inputs are received from the user through the user interface on the user device.

5. The system of claim 2, wherein at least one of the financial wellness assessment inputs are received automatically through accessing user profile information or user account information stored on the one or more financial institution systems.

6. The system of claim 2, wherein the financial situation score is based on financial wellness assessment questions related to the user's assets and the user's liabilities.

7. The system of claim 2, wherein the day-to-day financial management score is based on financial wellness assessment questions related to the user's liquidity management, budgeting, debt management, and financial planning.

8. The system of claim 2, wherein the preparing for the future score is based on financial wellness assessment questions related to the user's education management, personal development, investing management, retirement planning, insurance management, and estate planning.

9. The system of claim 1, wherein the one or more processing devices are configured to execute the computer readable program code to:
predict one or more problems associated with the user; and
perform a stress test configured to test the user's ability to handle the predicted one or more problems, thereby resulting in a stress score.

10. The system of claim 9, the one or more processing devices are configured to execute the computer readable program code to:
in response to the stress score moving past a threshold, present second actionable advice to the user, the second actionable advice configured to improve the user's ability to handle the predicted one or more problems.

11. A computer program product for transforming user information into a determination of the overall wellness and/or overall intelligence of a user and triggering one or more actions configured to improve the overall wellness and/or overall intelligence of the user, the computer program product comprising at least one non-transitory computer-readable medium having computer-readable program code portions embodied therein, the computer-readable program code portions comprising:
an executable portion configured to, based on user information, determine an overall wellness score and/or an overall intelligence score;
identify one or more rules from a plurality of rules for one or more of the wellness questions or the personal characteristic questions, wherein the one or more rules are used to determine actionable advice for the user, wherein the actionable advice is determined when a threshold response for the one or more rules is violated by the wellness assessment inputs or the personal characteristic inputs, and wherein the plurality of rules are stored on one or more servers;
present the actionable advice to the user on the user interface of the user device, wherein the actionable advice comprises tips, articles, or offers associated with the one or more rules that were violated by the wellness assessment inputs or the personal characteristic inputs, wherein the actionable advice is related to improving the overall wellness score of the user, wherein the actionable advice is stored on one or more servers, and wherein the actionable advice comprises tips, articles, or offers that are identified from third-party systems or one or more institution systems;
determine that the user has taken one or more actions corresponding to the actionable advice, thereby improving the overall wellness score or the overall intelligence score;
based on determining that the overall wellness score or the overall intelligence score has improved, present a recommended product offer to the user.

12. The computer program product of claim 11, wherein determining the financial wellness score comprises:
presenting personal characteristic questions to the user, wherein the personal characteristic questions comprise financial history information about the user and the user's household, and wherein the personal characteristic questions are presented to the user through a user interface on a user device;
receiving personal characteristic inputs in response to the personal characteristic questions;
determining financial wellness assessment questions to present to the user from a plurality of financial wellness assessment questions, wherein the financial wellness assessment questions are determined based on the personal characteristic inputs received for the personal characteristics questions, wherein the financial wellness assessment questions relate to the user's financial situation, the user's day-to-day financial management, and the user's preparation for the future, and wherein the plurality of financial wellness assessments questions are stored on one or more servers;
presenting the financial wellness assessment questions to the user, wherein the financial wellness assessment questions are presented to the user on the user interface of the user device;
receiving financial wellness assessment inputs from the user in response to the financial wellness assessment questions, wherein the financial wellness assessment inputs are received from the user through the user interface on the user device;
transforming the financial wellness assessments inputs from the user into a financial situation score that measures a value of the user's net worth, a day-to-day financial management score that measures how the user handles current finances, and a preparing for the future score that measures how the user plans for long-term financial needs; and
transforming the financial situation score, the day-to-day financial management score, and the preparing for the future score into an overall financial wellness score.

13. The computer program product of claim 12, wherein the personal characteristic inputs are received automatically through accessing user profile information or user account information stored on the one or more financial institution systems.

14. The computer program product of claim 12, wherein the personal characteristic inputs are received from the user through the user interface on the user device.

15. The computer program product of claim 12, wherein at least one of the financial wellness assessment inputs are received automatically through accessing user profile information or user account information stored on the one or more financial institution systems.

16. The computer program product of claim 12, wherein the financial situation score is based on financial wellness assessment questions related to the user's assets and the user's liabilities.

17. The computer program product of claim 12, wherein the day-to-day financial management score is based on financial wellness assessment questions related to the user's liquidity management, budgeting, debt management, and financial planning.

18. The computer program product of claim 12, wherein the preparing for the future score is based on financial wellness assessment questions related to the user's education management, personal development, investing management, retirement planning, insurance management, and estate planning.

19. The computer program product of claim 11, wherein the one or more processing devices are configured to execute the computer readable program code to:
predict one or more problems associated with the user; and
perform a stress test configured to test the user's ability to handle the predicted one or more problems, thereby resulting in a stress score.

20. The computer program product of claim 19, the one or more processing devices are configured to execute the computer readable program code to:
in response to the stress score moving past a threshold, present second actionable advice to the user, the second actionable advice configured to improve the user's ability to handle the predicted one or more problems.

21. A method for transforming user information into a determination of the overall wellness and/or overall intelligence of a user and triggering one or more actions configured to improve the overall wellness and/or overall intelligence of the user, the method comprising:
based on user information, determine an overall wellness score and/or an overall intelligence score;
identify one or more rules from a plurality of rules for one or more of the wellness questions or the personal characteristic questions, wherein the one or more rules are used to determine actionable advice for the user, wherein the actionable advice is determined when a threshold response for the one or more rules is violated by the wellness assessment inputs or the personal characteristic inputs, and wherein the plurality of rules are stored on one or more servers;
present the actionable advice to the user on the user interface of the user device, wherein the actionable advice comprises tips, articles, or offers associated with the one or more rules that were violated by the wellness assessment inputs or the personal characteristic inputs, wherein the actionable advice is related to improving the overall wellness score of the user, wherein the actionable advice is stored on one or more servers, and wherein the actionable advice comprises tips, articles, or offers that are identified from third-party systems or one or more institution systems;
determine that the user has taken one or more actions corresponding to the actionable advice, thereby improving the overall wellness score or the overall intelligence score;
based on determining that the overall wellness score or the overall intelligence score has improved, present a recommended product offer to the user.
